(19) United States
(12) Patent Application Publication
(10) Pub. No.: US 2005/0088076 A1
(43) Pub. Date: Apr. 28, 2005

(54) Fluorescent lamp

(76) Inventor: Chi-Jung Chu, Kaohsiung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/694,094

(22) Filed: Oct. 27, 2003

(51) Int. Cl. H01J 7/44; H01J 17/16

(52) U.S. Cl. 313/493

(57) ABSTRACT

A fluorescent light includes a base, a lamp seat, and an illuminating tube. The lamp seat includes a cover securely mounted to the base and a housing that receives an illuminating circuit. The illuminating tube has two ends mounted to the base. The illuminating tube defines a compartment in which the housing is received. The fluorescent lamp can be used with a lamp-mounting base for a conventional incandescent lamp without increasing the overall length of the whole illuminating system while providing improved illumination effect.

### BACKGROUND OF THE INVENTION

1. Field of the Invention

The present invention relates to a fluorescent lamp with improved illumination effect.

2. Description of the Related Art

Fluorescent lamps or gas discharge lamps output light beams by means of providing electricity to the inert gas in the illuminating tubes to discharge. The illuminating tube of a fluorescent lamp is conventionally rectilinear or annular. Lately, illuminating tubes of U-shaped, spiral, and helical shapes have been proposed. The fluorescent lamps have advantages such as generating no heat, having a longer life, and saving electricity in comparison with incandescent lamps.

Several fluorescent lamps of the type having a U-shaped illuminating tube are arranged in an array to provide sufficient illumination. However, the illumination is not uniform, i.e., some areas are bright enough, but others are unacceptably dark. To solve this problem, several fluorescent lamps of the type having a U-shaped illuminating tube are arranged annularly or concentrically to provide uniform illumination while saving electricity. Nevertheless, the construction is complex.

FIG. 1 of the drawings illustrates a conventional fluorescent lamp 1 that is proposed to solve the problem of fluorescent lamps of the type having a U-shaped illuminating tube. The fluorescent lamp 1 in FIG. 1 is upside down and includes a base 11, a lamp seat 12, and an illuminating tube 13. The base 11 includes an outer threading 111 to be mounted to a lamp-mounting base of a conventional incandescent lamp. The lamp seat 12 includes a substantially bowl-like body 121 and an upper lid 122. Provided in the bowl-like body 121 and adjacent to the lamp base 11 is a circuitry room 123 for receiving elements 14 of an illuminating circuit. The illuminating tube 13 includes two helical tube sections each having an end 131 mounted in the upper lid 122 of the lamp seat 12. The end 131 of the respective helical tube section of the illuminating tube 13 includes an electrode 132 electrically connected to the illuminating circuit.

Compared to the conventional U-shaped fluorescent lamp, the fluorescent lamp with two helical tube sections provides increased luminance and more uniform light beams while having a simplified structure. The base 11, however, cannot be used with a conventional lamp-mounting base for an incandescent lamp. In particular, the lamp seat 12 between the base 11 and the illuminating tube 13 of the fluorescent lamp 1 has a considerable volume for receiving the elements 14 of the illuminating circuit, which results in an excessively long fluorescent lamp (including the length of the illuminating tube 13 for improving the illumination effect) in comparison with a conventional incandescent lamp. Further, the light beams illuminated by an upper portion 133 of the illuminating tube 13 is obstructed by a lower portion 134 of the illuminating tube 13.

### SUMMARY OF THE INVENTION

An object of the present invention is to provide a fluorescent lamp that can be used with a lamp-mounting base for a conventional incandescent lamp without increasing the overall length of the lamp.

Another object of the present invention is to provide a fluorescent lamp providing improved illumination effect.

In accordance with an aspect of the invention, a fluorescent light includes a base, a lamp seat, and an illuminating tube. The lamp seat includes a cover securely mounted to the base and a housing that receives an illuminating circuit. The illuminating tube has two ends mounted to the base. The illuminating tube defines a compartment in which the housing is received. The fluorescent lamp can be used with a lamp-mounting base for a conventional incandescent lamp without increasing the overall length of the whole illuminating system while providing improved illumination effect.

Other objects, advantages, and novel features of the invention will become more apparent from the following detailed description when taken in conjunction with the accompanying drawings.

### BRIEF DESCRIPTION OF THE DRAWINGS

FIG. 1 is an upside-down perspective view of a conventional fluorescent light.

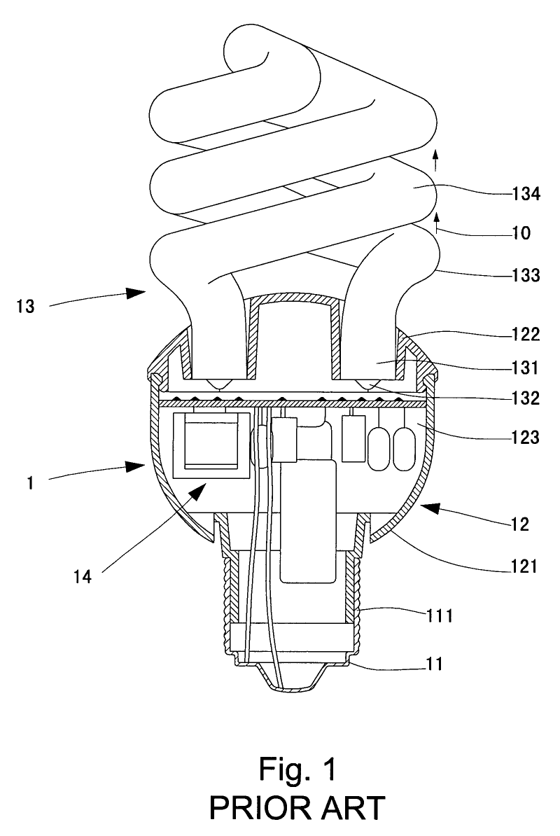

FIG. 2 is an upside-down perspective view of a fluorescent lamp in accordance with the present invention.

FIG. 3 is an exploded perspective view of the fluorescent lamp in accordance with the present invention.

FIG. 4 is a sectional view of the fluorescent lamp in accordance with the present invention.

FIG. 5 is a sectional view of a modified embodiment of the fluorescent lamp in accordance with the present invention.

### DETAILED DESCRIPTION OF THE PREFERRED EMBODIMENTS

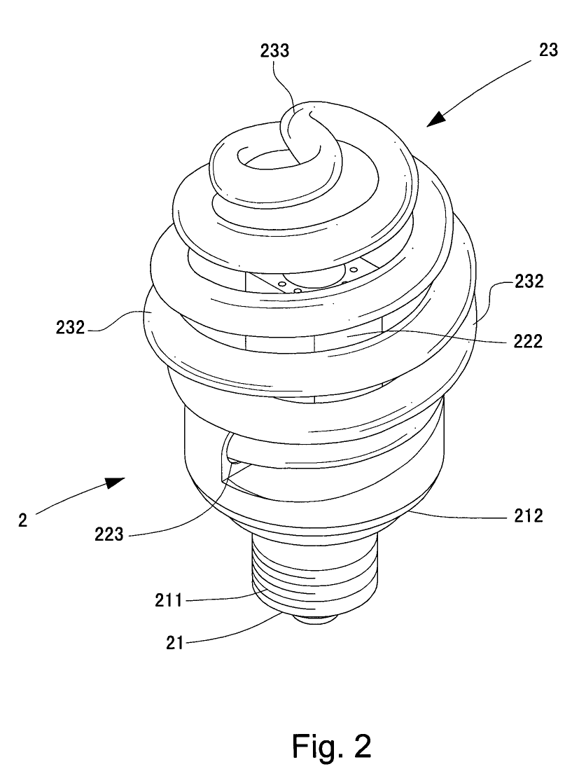

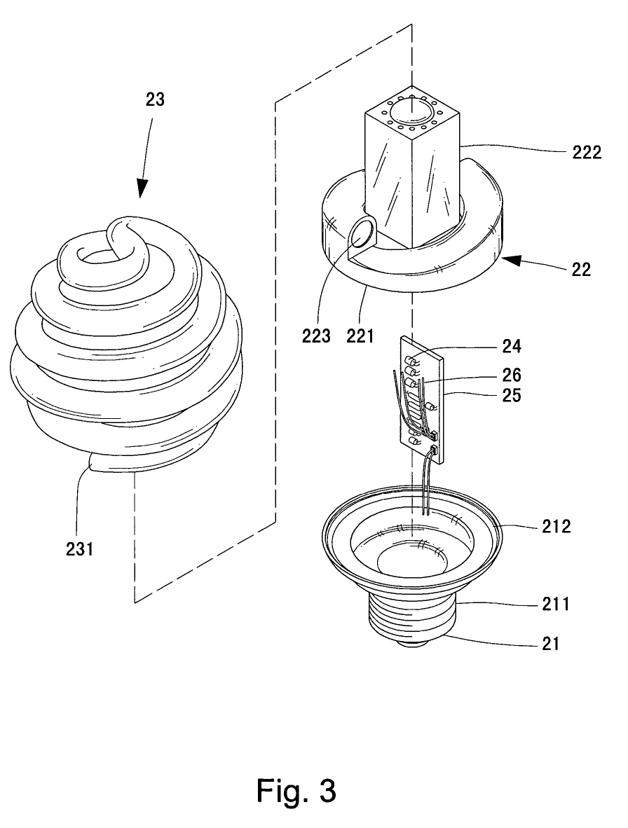

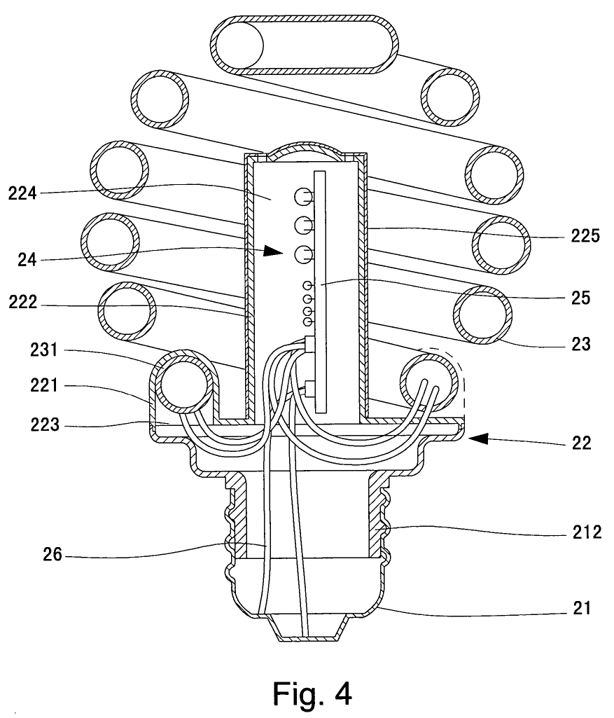

Referring to FIGS. 2 through 4, a fluorescent lamp 2 in accordance with the present invention generally comprises a base 21, a lamp seat 22, and an illuminating tube 23. The base 21 includes an outer threading 211 for engaging with an inner threading (not shown) of a lamp-mounting base (not shown) for a conventional incandescent lamp (not shown). The base 21 includes a disc portion 212 on an inner side thereof for mounting the lamp seat 22 thereon.

The lamp seat 22 includes a cover 221 and a housing 222 projecting from a side of the cover 221. The cover 221 covers an interior of the base 21 and includes two openings 223 for receiving two ends 231 of the illuminating tube 23. The housing 222 defines a compartment 224 for receiving elements 24 for an illuminating circuit mounted on a circuit board 25. The elements 24 are electrically connected by wires 26 to the base 21 and the illuminating tube 23. Each end 231 of the illuminating tube 23 has an electrode (not shown).

The illuminating tube 23 is a winding tube in which fluorescent discharging is performed. In particular, inert gas (not shown) is filled into the winding tube, and fluorescent substances (not shown) are applied to an inner side of the winding tube. The respective end 231 of the illuminating tube 23 is received in the respective opening 223 of the cover 221. When electricity is supplied to the illuminating tube 23, high-energy electrons emitted by the electrodes cause the inert gas in the illuminating tube 23 to discharge and generate visible light beams and ultraviolet beams. The invisible ultraviolet beams are absorbed by the fluorescent substances and become outwardly emitting visible light beams. This process is repeated as long as electricity is applied, providing continuous illumination.

It is noted that the housing 222 that receives the elements 24 of an illuminating circuit extends into an interior space defined by the illuminating tube 23. Thus, the overall length of the fluorescent lamp 2 is substantially the same as that of a conventional incandescent lamp. Namely, the fluorescent lamp 2 can be used with a lamp-mounting base for a conventional incandescent lamp without increasing the overall length of the whole illuminating system. The illuminating tube 23 and the lamp seat 22 together define a spherical outline as those of a conventional incandescent lamp. As well known in the art, the fluorescent lamp 2 provides increased luminance. A reflective layer 225 may be applied to an outer periphery of the housing 222 such that light beams incident to the outer periphery of the housing 222 are reflected, providing a second illumination and thus increasing the illumination effect.

The illuminating tube 23 in FIGS. 2 through 4 has two ends 231 respectively received in the openings 223 of the lamp seat 22. The illuminating tube 23 further includes two helical illuminating tube sections 232 respectively extending from the ends 231 of the illuminating tube 23 in a direction away from the base 21 and merging with each other at an apex 233.

Preferably, the helical illuminating tube sections 232 are helically wound around a longitudinal axis of the fluorescent lamp 2 passing through the apex 233. Further, the radius of each helical illuminating tube section 232 increases and then decreases in a direction away from the base 22. Further, the helical illuminating tube sections 232 are so configured that the helical illuminating tube sections 232 are spaced from each other except the common apex 233 when viewed from a plane orthogonal to the longitudinal axis. By this arrangement, the light beams illuminated by an upper portion of the illuminating tube 23 will not be obstructed by a lower portion of the illuminating tube 23 when in use. The illumination is more uniform.

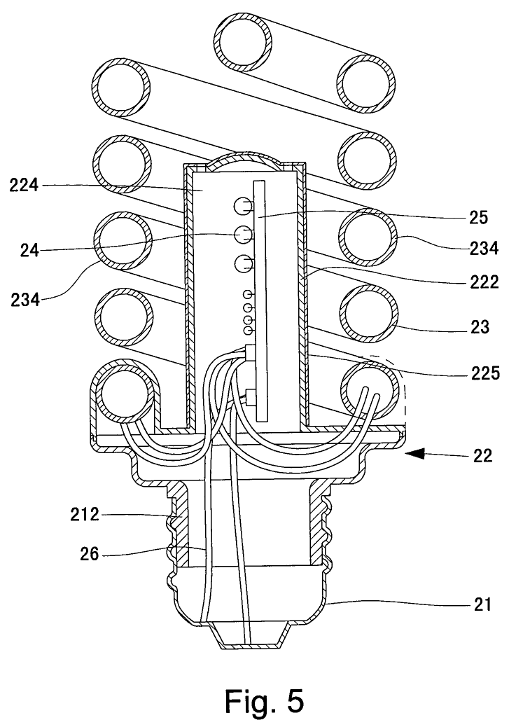

FIG. 5 shows a modified embodiment of the illuminating tube. In this embodiment, the illuminating tube 23 includes two helical illuminating tube sections 234 with the same radius.

Although the invention has been explained in relation to its preferred embodiment, it is to be understood that many other possible modifications and variations can be made without departing from the scope of the invention as hereinafter claimed.

1. A fluorescent lamp comprising:
a base;
a lamp seat including a cover and a housing, the cover being securely mounted to the base, the housing receiving an illuminating circuit; and
an illuminating tube having two ends mounted to the base, the illuminating tube defining a compartment in which the housing is received.

2. The fluorescent lamp as claimed in claim 1, wherein the base includes a disc for engaging with the cover of the lamp seat.

3. The fluorescent lamp as claimed in claim 1, wherein the cover includes two openings for respectively receiving the ends of the illuminating tube.

4. The fluorescent lamp as claimed in claim 1, wherein the illuminating tube has two helical illuminating tube sections respectively extending from the ends of the illuminating tube in a direction away from the base and merging with each other at an apex.

5. The fluorescent lamp as claimed in claim 4, wherein a radius of each of the helical illuminating tube sections increases and then decreases in the direction away from the base.

6. The fluorescent lamp as claimed in claim 4, wherein the helical illuminating tube sections have the same radius.

7. The fluorescent lamp as claimed in claim 1, wherein the illuminating tube and the lamp seat together define a spherical outline.

8. The fluorescent lamp as claimed in claim 1, wherein the housing further includes a reflective layer applied to an outer periphery thereof.

9. The fluorescent lamp as claimed in claim 4, wherein the base includes a disc for engaging with the cover of the lamp seat.

10. The fluorescent lamp as claimed in claim 4, wherein the cover includes two openings for respectively receiving the ends of the illuminating tube.

11. The fluorescent lamp as claimed in claim 4, wherein the illuminating tube and the lamp seat together define a spherical outline.

12. The fluorescent lamp as claimed in claim 4, wherein the housing further includes a reflective layer applied to an outer periphery thereof.
